(19) United States
(12) Patent Application Publication
(10) Pub. No.: US 2024/0261704 A1
(43) Pub. Date: Aug. 8, 2024

(54) INTERCHANGEABLE CHROMATOGRAPHY CARTRIDGE ADAPTER SYSTEM

(71) Applicant: SUPERCRITICAL FLUID TECHNOLOGIES, INC., Newark, DE (US)

(72) Inventors: Kenneth Richard Krewson, Allentown, NJ (US); Andrew Cloud, Wilmington, DE (US); Kenneth Joseph James, Newark, DE (US); Curtis EBERSOLD, Elkton, MD (US); Kim FERRARA, Middletown, DE (US)

(21) Appl. No.: 18/623,582

(22) Filed: Apr. 1, 2024

Related U.S. Application Data
(63) Continuation-in-part of application No. 17/416,964, filed on Jun. 21, 2021, now Pat. No. 11,946,915.
(60) Provisional application No. 62/788,724, filed on Jan. 4, 2019.

(51) Int. Cl. B01D 15/22; B01D 15/20; B01D 53/02

(52) U.S. Cl. CPC B01D 15/22; B01D 15/20; B01D 53/025; B01D 2256/22

(57) ABSTRACT

A chromatography system has a cartridge adapter that is detachably attachable to enable a chromatography cartridge to be quickly interchanged. Chromatography cartridges are configured with threads for coupling to a corresponding interchangeable coupling component having matching threads. The interchangeable coupling component may be secured to the chromatography system by a coupling retainer. A coupling retainer may have a keyway that is configured for quick interchanging of the interchangeable coupling components. The interchangeable coupling component may have a pair of parallel sides that align with a slot of the keyway to secure the interchangeable coupling components to the coupling retainer. An inlet nipple of the chromatography cartridge may extend through an opening in the coupling components and couple to an inlet conduit for sample gas. Analyte gas may flow back to the chromatography system for detection and collection.

This application is a Continuation-in-part of U.S. patent application Ser. No. 17/416,964, filed Jun. 21, 2021, now U.S. Pat. No. 11,946,915, issued Apr. 2, 2024, which is a U.S. National Phase application of International Application No. PCT/US2020/012275, filed Jan. 3, 2020, which claims priority to U.S. Provisional Patent Application No. 62/788,724, filed on Jan. 4, 2019, all of which are incorporated herein by reference in their entireties for all purposes.

### BACKGROUND OF THE INVENTION

### Field of the Invention

The present invention relates chromatography system having a cartridge adapter for quickly interchanging chromatography cartridge.

### Background

Chromatography system utilize cartridges packed with absorbents to separate out components of a sample from a solvent. The cartridges have to be changed out between samples. The cartridges are typically clamped and sealed to the chromatography system and coupled to a sample gas inlet. The outlet from the cartridge is coupled to a detector for analysis. The process of changing out the cartridges is laborious and time consuming.

### SUMMARY OF THE INVENTION

The invention is directed to a chromatography system having a cartridge adapter that is detachably attachable to enable chromatography cartridge to be quickly interchanged. An exemplary chromatography system comprises chromatography cartridges that are configured with threads for coupling with a corresponding interchangeable coupling component having matching threads. The interchangeable coupling component may be secured to the chromatography system by a coupling retainer. A coupling retainer may have a key way that is configured for quick interchanging of the interchangeable coupling components. The interchangeable coupling component may have a pair of parallel sides that align with a slot of the keyway to secure the interchangeable coupling components to the coupling retainer. An inlet nipple of the chromatography cartridge may extend through an opening in the coupling components and couple with an inlet conduit for sample gas. Analyte gas may flow back to the chromatography system for detection and collection. It is to be understood that the sample and analyte may be a gas, a liquid or a supercritical fluid, such as carbon dioxide; the term gas may be used throughout however, for simplicity.

An exemplary chromatography system comprises chromatography cartridges having threads of different sizes, such as different diameters or different pitch configurations. The threads of the chromatography cartridges may be configured proximal to the inlet end, such as around the outer diameter of the cartridge. The threads of the cartridge may be male threads and the threads of the interchangeable coupling component may be female threads or the threads of the cartridge may be female threads and the threads of the interchangeable coupling component may be male threads. An exemplary chromatography cartridge has an inlet on an inlet end and an inlet nipple may extend from the inlet end. The inlet nipple may extend through an opening in the interchangeable coupling component to couple with an inlet gas conduit, for receiving sample gas. An exemplary chromatography cartridge has an outlet on an outlet end that is coupled to a detector. An outlet conduit may extend from the outlet of the cartridge to the detector or to the cartridge adapter and subsequently to the detector.

An exemplary interchangeable coupling component has threads for coupling with the threads on a cartridge. The plurality of interchangeable coupling components may be provided for coupling with different threads of different size or type cartridges. An exemplary interchangeable coupling component has a cartridge end for coupling with the cartridge and a retainer portion that is retained by the coupling retainer. An exemplary retainer portion extend from the cartridge portion and has a planar side or a pair of opposing parallel planar sides that are retained int the retainer slot of the coupling retainer. The planar sides may extend a portion of the length of the retainer portion the extended end of the retainer portion may have a circular cross-section that extends through the coupling retainer to the chromatography side of the coupling retainer. An exemplary interchangeable coupling component has an opening, such as a centrally located opening that extends from the cartridge end to the retainer end to receive the inlet nipple of a cartridge.

An exemplary coupling retainer is configured for quickly coupling with an interchangeable coupling component and has a keyway having a coupling aperture for receiving the retainer end therethrough and a retainer slot that is configured around the pair of parallel sides of the retainer portion of the interchangeable coupling component. The interchangeable coupling component is inserted through the coupling aperture of the keyway and then the coupling component is then slid or move to configure the retainer slot around the pair of parallel sides of the retainer portion. This enables quick interchange of coupling components and therefore quick interchanging of cartridges. An exemplary coupling component comprises a fastener slot or preferably a pair of fastener slots that allow a fastener to retain the coupling retainer to the chromatography system while allowing it to slid or move for positioning the retainer slot around the interchangeable coupling component. The inlet nipple of the cartridge may extend through the keyway opening of the coupling retainer.

An exemplary chromatography system may comprise an interface component that is configured between the coupling retainer and the chromatography system or a fixed component. The fasteners that extend through the fastener slots of the coupling retainer may be secured into fastener apertures of the interface component, which may be threaded apertures for receiving a bolt, for example. An exemplary interface component may have apertures for fasteners to extend therethrough and into a fixed component of the chromatography system. One or more seals may be configured between components to prevent leakage of gases.

A method of changing out cartridges comprises, first removing a first cartridge and interchangeable coupling component from the chromatography system. The cartridge may be detached from the coupling component and then the coupling component can be removed by moving the coupling retainer and associated keyway to align the coupling aperture with the retainer end. A second and different cartridge, having different threads, may then be attached to the chromatography system. A new interchangeable coupling component configured for attachment to the second cartridge may first be configured with the retainer portion through the coupling retainer of a second coupling retainer. The keyway of the second coupling retainer may then be slid to align the retainer slot around the pair of parallel sides of the retainer portion of the second interchangeable coupling component. The second cartridge may then be secured to the second interchangeable coupling component by screwing the two components together. It is to be understood that the chromatography system and the cartridge adapter may be configured for any number of cartridges, which may all have different threads for attachment to a cartridge adapter.

An exemplary chromatography system utilizes a cartridge adapter, having a cartridge body, configured to receive a chromatography cartridge and configured for coupling with a cartridge adapter receiver of the chromatography system. The chromatography cartridge is detachably attachable to the cartridge adapter and the cartridge adapter is detachably attachable to the cartridge adapter receiver of the chromatography system. One or more springs elements, such as a coiled spring or elastomeric material, may be configured on a retainer surface of the cartridge adapter and configured to engage with an adapter retainer surface of an adapter retainer, to create a firm connection of the cartridge adapter with the cartridge adapter receiver, to prevent leaks of an analyte composition. The cartridge body may be a monolithic part made from a single piece of material, such as being machined or otherwise made from a piece of metal.

An exemplary cartridge adapter has a cartridge key configured to fit within a keyway recess extending from an adapter recess of a cartridge adapter receiver. The cartridge adapter may have a cartridge recess for receiving a chromatography cartridge therein and for coupling the inlet nipple of the chromatography cartridge with the inlet conduit. The inlet nipple of the chromatography cartridge may be a male fitting that is inserted into the cartridge adapter to couple the inlet nipple with the inlet conduit into the chromatography cartridge. Also, the cartridge adapter has a centering feature for centering within the cartridge receiver. The centering feature is a recess in the retainer surface of the cartridge adapter and may be configured to receive a tool for removal of the cartridge adapter from the cartridge adapter receiver. The cartridge adapter body forms an insert surface and the cartridge key extends from this engagement surface to form a protrusion from the insert surface for insertion into the keyway recess that enables effective alignment.

An exemplary chromatography cartridge has an inlet end with an inlet and inlet nipple, and an outlet end with an outlet and outlet nipple. The outlet nipple may be a male connector and the inlet nipple may be a female connector. The chromatography cartridge has an absorbent therein. Sample gas, comprising a solvent and a specimen, flows into the inlet through the inlet nipple of the chromatography cartridge and an analyte gas flows out of the outlet through the outlet nipple of the cartridge and to a detector of the chromatography system.

The exemplary chromatography cartridge is inserted into the cartridge adapter and the cartridge adapter has a cartridge key that extends from the insert surface for locating the cartridge adapter in a chromatography cartridge receiver. The inlet nipple is coupled with the inlet conduit of the cartridge adapter. The outlet nipple s configured for coupling with the cartridge outlet nipple receiver of the cartridge adapter receiver.

A cartridge adapter receiver of a chromatography system has adapter opening that extends in to a cartridge receiver surface. A keyway for receiving the cartridge key of the cartridge adapter extends distal from insert surface of the cartridge adapter with respect to the adapter opening in the cartridge adapter receiver. The cartridge key may extend a fraction the cartridge receiver surface and may extend about 40 degrees or less, about 30 degrees or less, about 20 degrees or less so that the cartridge receiver surface provides a substantial surface for the insert surface of the cartridge adapter. Likewise, the keyway recess may be sized to correspond with the cartridge key and may extend about 40 degrees or less, about 30 degrees or less, about 20 degrees or less within the adapter opening or from the cartridge receiver surface. The chromatography cartridge adapter receiver has a keyway, a recessed area from the adapter recess that is sized for positive rotational location of the cartridge adapter therein. A process flow inlet coupler for coupling with the process flow inlet of the cartridge adapter, and a cartridge outlet nipple receiver for coupling with the inlet nipple of the cartridge.

The process flow, includes an analyte suite composition, which may include one to seven analytes, a super critical CO2 and a solvent, are introduced through the process flow inlet coupler which couples with the process flow inlet of the cartridge adapter. The analyte suite composition then flows through the process flow conduit to the inlet nipple of the chromatography cartridge, through the cartridge and the absorbent, such as a silica media, to the outlet nipple of the chromatography cartridge. The absorbent causes the analytes to pass through the cartridge at different speeds to stratify the analytes into separate analytes for analysis. The analytes then flow the cartridge outlet nipple receiver to then detector for analysis.

An adapter retainer has an adapter-retainer surface configured to engage with the retainer surface of the cartridge adapter and has retainer flanges configured to rotate under the receiver flanges to secure the cartridge adapter to the cartridge adapter receiver. The adapter retainer may have a handle portion that extends out from the adapter recess or from the cartridge adapter receiver, to allow a user to push the adapter retainer inward and rotate it to secure the receiver flanges against the retainer flanges. The spring elements are compressed to produce a force on the retainer flanges against the receiver flanges to secure the cartridge adapter in position within the adapter recess. Sealing the nipples of the chromatography cartridge to the cartridge adapter and process flow inlet with the process flow inlet coupler is difficult and often requires multiple attempts to get all three connections to seal simultaneously. The use of these spring elements aids in alignment and compression sealing of each of the three connections to ensure the process flow through the system. It is important to keep the process flow through the cartridge and not into the recess and to prevent gas, not process flow, into the analyte composition.

The summary of the invention is provided as a general introduction to some of the embodiments of the invention, and is not intended to be limiting. Additional example embodiments, including variations and alternative configurations of the invention, are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows an exemplary chromatography cartridge having threads for coupling with an interchangeable coupling component of an exemplary cartridge adapter.

FIG. 2 shows an exemplary chromatography cartridge having threads of a different dimension from that shown in FIG. 1.

FIG. 3 shows top cross sectional view of a chromatography system comprising an exemplary cartridge adapter and a cartridge retained by said cartridge adapter.

FIG. 4 shows perspective view of a chromatography system comprising an exemplary cartridge adapter and a cartridge retained by said cartridge adapter.

FIGS. 5 and 6 show an exemplary coupling component comprising threads for coupling with the threads of a cartridge and a retainer end for insertion into the keyway of the coupling retainer.

FIG. 7 shows a front view of an exemplary coupling retainer having a keyway and coupling aperture to receive the retainer end of a coupling component.

FIG. 8 shows a perspective view of an exemplary coupling retainer having a keyway and coupling aperture to receive the retainer end of a coupling component.

FIG. 9 shows a perspective view of an exemplary cartridge adapter comprising a coupling component that is retained by a coupling retainer.

FIG. 10 shows a cross sectional view of an exemplary cartridge adapter comprising a coupling component that is retained by a coupling retainer and an inlet conduit for coupling to an inlet nipple of a cartridge.

FIG. 11 shows a perspective view of an exemplary interface component having apertures for coupling the interface component to the fixed component and apertures for retaining the coupling component to the interface component by fasteners, such as bolts.

FIG. 12 shows a cross sectional view of an exemplary interface component having an outlet conduit and outlet for the analyte gas.

FIG. 13 shows a perspective view of an exemplary fixed component having apertures for coupling the fixed component to the chromatography device by fasteners, such as bolts.

FIG. 14 shows a cross sectional view of an exemplary fixed component having an inlet conduit and inlet for the sample gas.

FIG. 15 shows a perspective view of a cartridge adapter having a cartridge key configured to fit within a keyway of a chromatography cartridge receiver.

FIG. 16 shows a side view of the cartridge adapter shown in FIG. 15.

FIG. 17 shows a cross-sectional view of the cartridge adapter shown in FIG. 15 along line 17 shown in FIG. 20.

FIG. 18 shows a back view of the cartridge adapter shown in FIG. 15.

FIG. 19 shows a top view of the cartridge adapter shown in FIG. 15.

FIG. 20 shows a side view of an exemplary chromatography cartridge.

FIG. 21 shows a side view of an exemplary chromatography cartridge inserted into the cartridge adapter and the cartridge adapter having a cartridge key for locating the cartridge adapter in a chromatography cartridge receiver.

FIG. 22 shows a front view of a cartridge adapter receiver of a chromatography system having a keyway for receiving the cartridge key of the cartridge adapter.

FIG. 23 shows a side view of the cartridge adapter having a chromatography cartridge therein, and inserted into the cartridge receiver.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

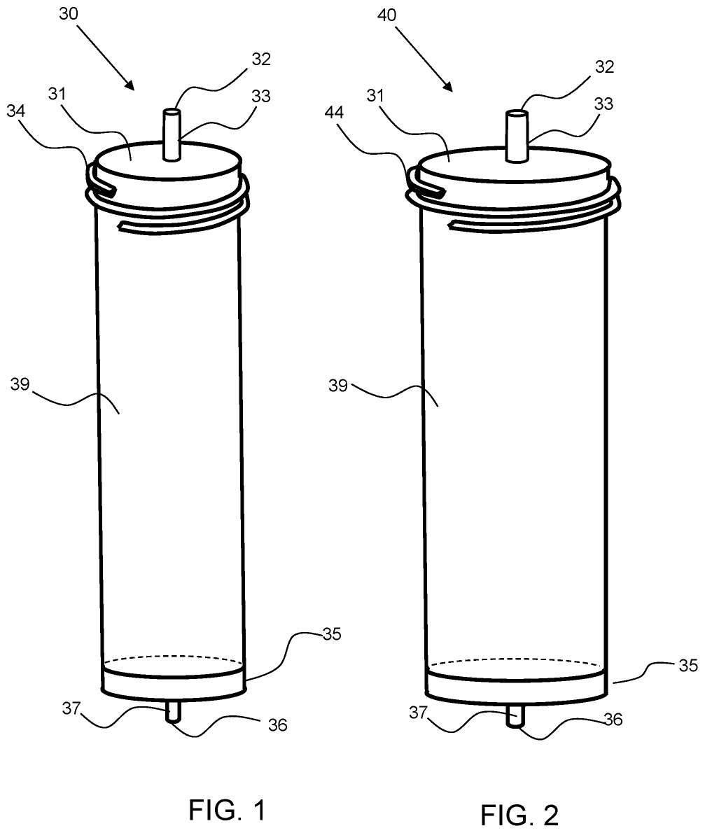

As shown in FIG. 1, an exemplary chromatography cartridge 30 has threads 34 for coupling with an interchangeable coupling component of an exemplary cartridge adapter. This first cartridge is smaller than the second cartridge 40, shown in FIG. 2. The first cartridge 30 has threads 34 that are smaller in dimension than the threads 44 of the second cartridge 40. Each of the cartridges have an inlet end 31, outlet end 35, inlet 32, inlet nipple 33, outlet 36, outlet nipple 37 and an absorbent 39 retained within the cartridge. Sample gas, comprising a solvent and a specimen, flows into the inlet and an analyte gas flows out of the outlet of the cartridge and to a detector of the chromatography system.

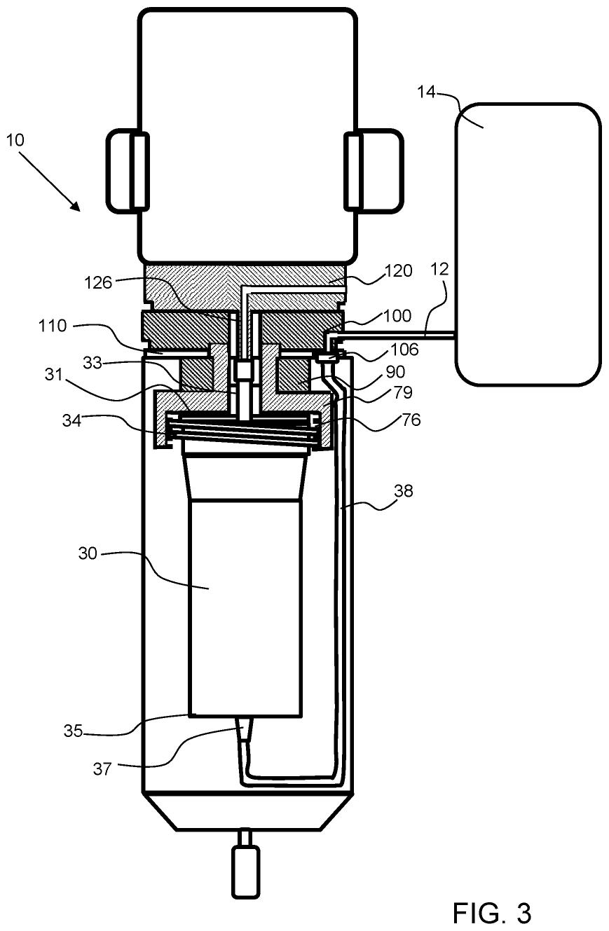

As shown in FIG. 3, an exemplary chromatography system 10 comprises a cartridge adapter 20 for retaining a cartridge 30 having threads 34. The threads of the cartridge are coupled to, screwed into, the threads 76 of the first cartridge adapter 70. The first cartridge adapter is configured with threads for coupling the first cartridge, and a second cartridge adapter is configured with threads for coupling a second cartridge; wherein the threads of the first and second cartridges are different geometry. The inlet nipple 33 is coupled to the inlet conduit 126 of the fixed component 126 and sample gas flow into the inlet coupling 127 and into the cartridge. The sample gas is separated to produce an analyte gas that flow out of the outlet of the cartridge, such as through the outlet nipple 37 through the outlet conduit 38 to a detector 14. The outlet conduit 38 is coupled to the interface cartridge adapter by the outlet coupling which is configured on the interface component, for example, and an analyte conduit 12 extends to the detector 14. This arrangement of the inlet coupling 127 and outlet conduit coupling 106 with a non-rotating portion of the cartridge adapter enables the cartridge to be spun or threaded onto or off of the coupling component without detaching the outlet conduit. The coupling component 70 is retained by the coupling retainer 90.

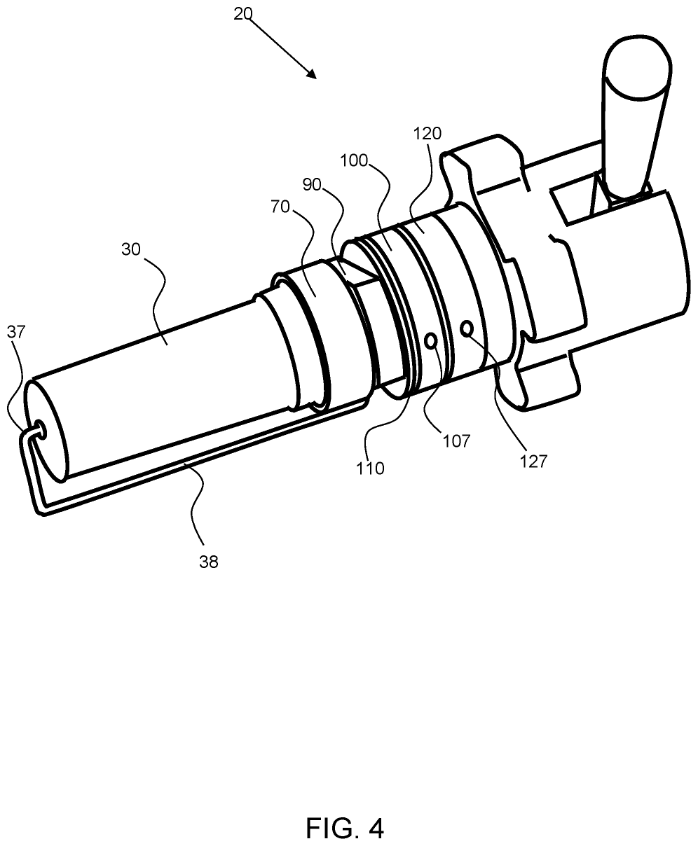

As shown in FIG. 4, a chromatography system comprises an exemplary cartridge adapter 20 and a cartridge 30 retained by said cartridge adapter. The inlet 127 for the sample gas is shown on the fixed component 120, and the outlet coupling 107 for the analyte gas is shown on the interface component 100. The cartridge 30 is screwed into the coupling component 70, and the coupling component is retained by the coupling retainer 90.

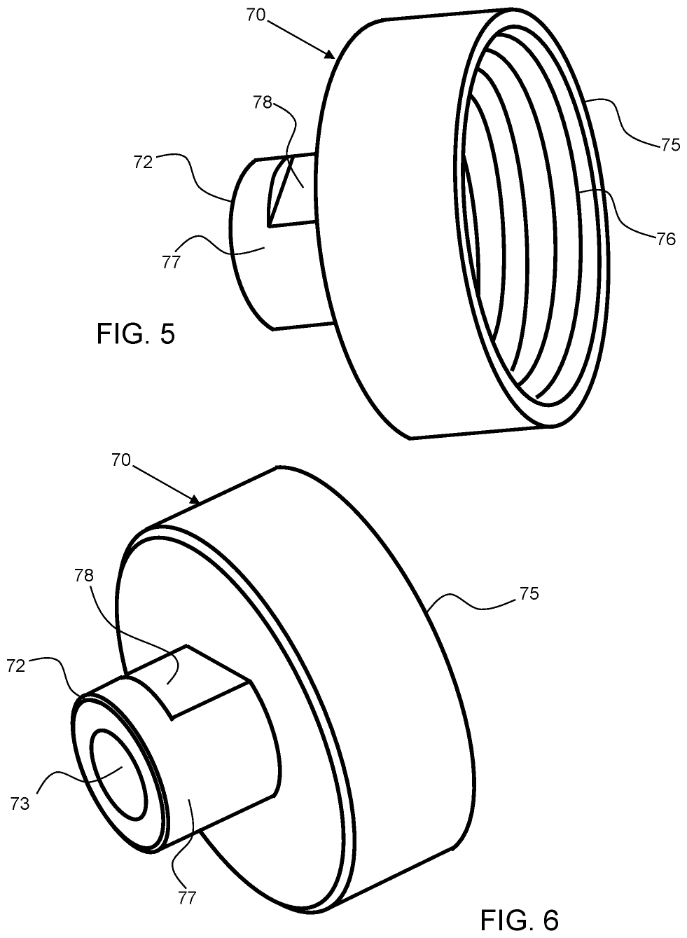

As shown in FIGS. 5 and 6, an exemplary coupling component 70 comprises threads 76 for coupling with the threads of a cartridge, and a retainer end 72 for insertion into the keyway of the coupling retainer. The coupling retainer has a large aperture in the keyway to receive the retainer end 72, and a smaller extension portion of the keyway, a retainer slot for example, for sliding over the planar side of the retainer portion 77. An exemplary coupling component has a pair of parallel planar sides to firmly secure the coupling component to the coupling retainer. The coupling component has an opening for the inlet of sample gas wherein the inlet nipple of the cartridge and/or the inlet conduit of the fixed component is configured therein or therethrough.

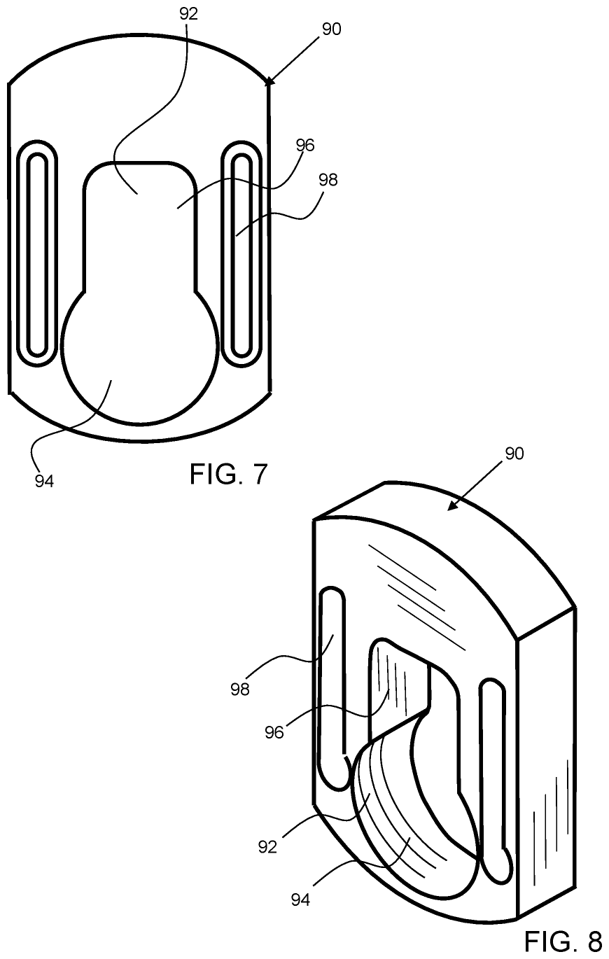

As shown in FIGS. 7 and 8, an exemplary coupling retainer 90 has a keyway 92 and coupling aperture 94 to receive the retainer end of a coupling component. The coupling aperture 94 of the keyway 92 is large in dimension, and the retainer slot 96 is smaller in dimension and has two parallel sides for engagement with the two parallel sides of the coupling component. The coupling retainer has fastener slots 98 for receiving a fastener, such as a bolt, that secures the coupling retainer to the interface component.

As shown in FIG. 9, an exemplary cartridge adapter 20 comprises a coupling component 70 that is retained by a coupling retainer 90. The inlet conduit 126 extends through the coupling component for coupling to the inlet nipple of the cartridge.

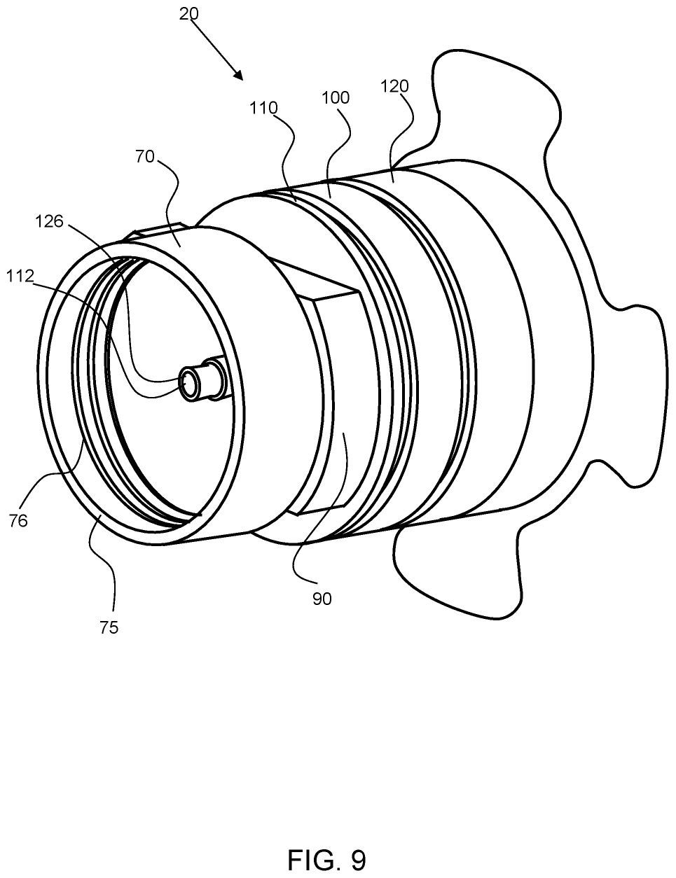

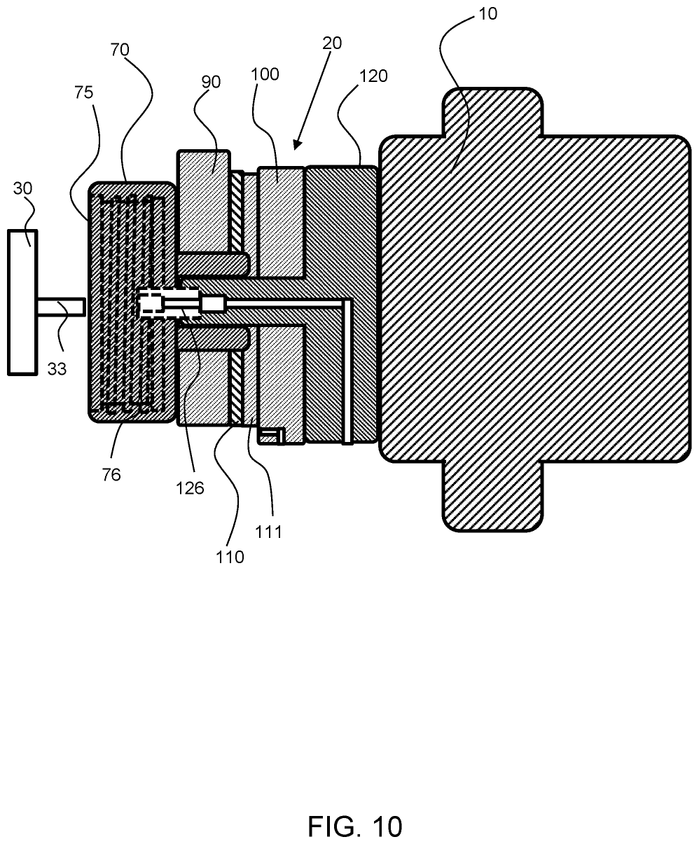

As shown in FIG. 10, an exemplary cartridge adapter 20 comprises a coupling component 70 that is retained by a coupling retainer 90 and an inlet conduit 126 for coupling to an inlet nipple 33 of a cartridge 30.

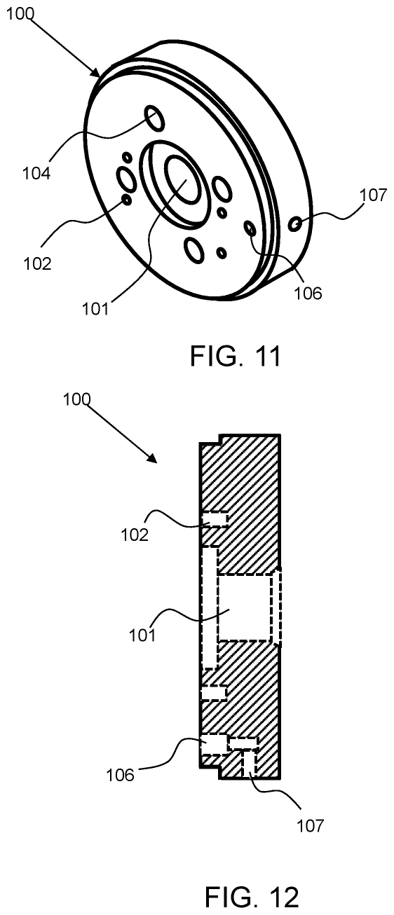

As shown in FIGS. 11 and 12, an exemplary interface component 100 has fixed component apertures 104 for coupling the interface component to the fixed component, and coupling retainer apertures 102 for retaining the coupling component to the interface component by fasteners, such as bolts. The interface component 100 has an outlet conduit coupling 106 and an outlet coupling 107 for the analyte gas.

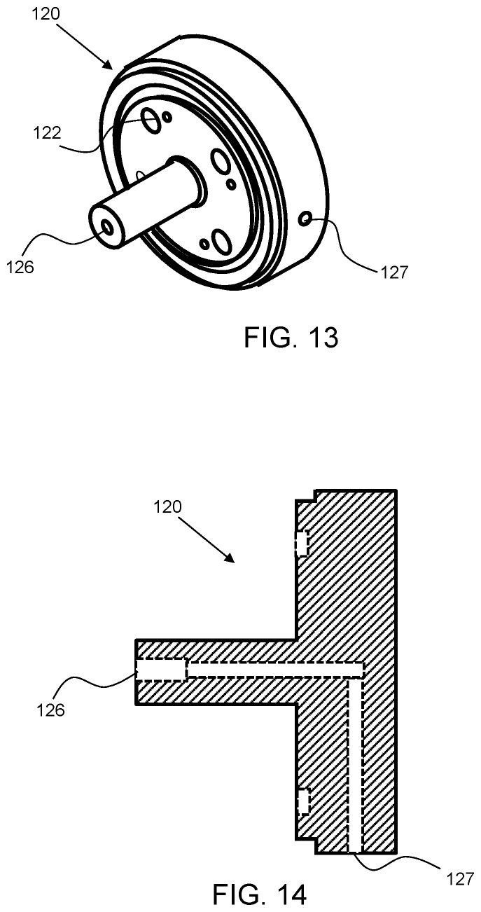

As shown in FIGS. 13 and 14, an exemplary fixed component 120 has interface retainer apertures 122 for coupling the interface component to the fixed component, and device apertures 122 for coupling the fixed component to the gas chromatography system by fasteners, such as bolts.

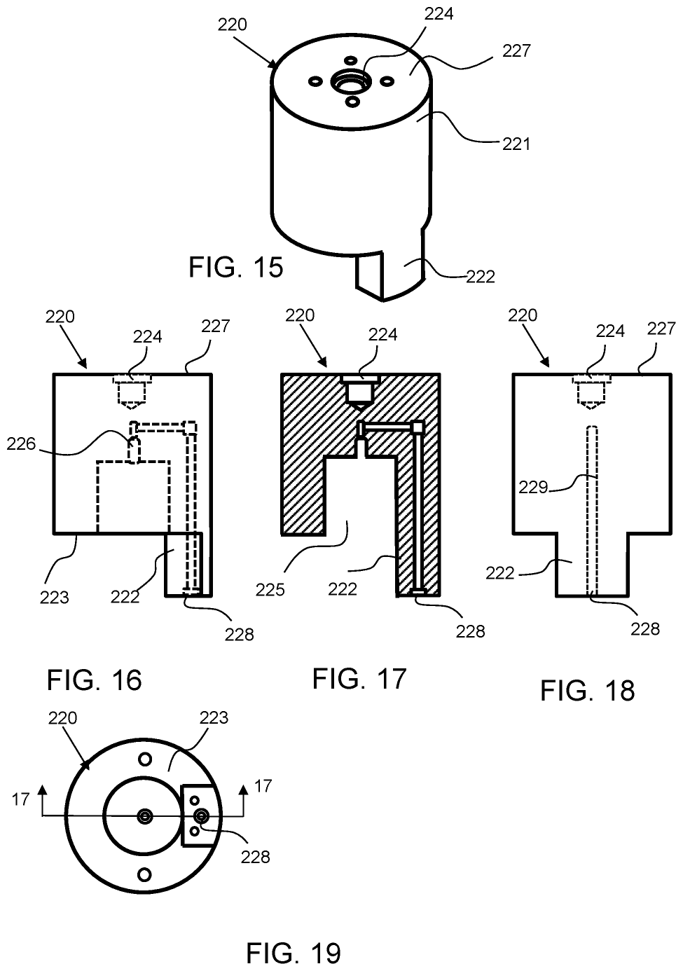

Referring now to FIGS. 15 to 23, an exemplary chromatography system 10 utilizes a cartridge adapter 220, having a cartridge body 221, configured to receive a chromatography cartridge 230 and configured for coupling with a cartridge adapter receiver of the chromatography system 10. The chromatography cartridge 230 is detachably attachable to the cartridge adapter 220 and the cartridge adapter 220 is detachably attachable to the cartridge adapter receiver 210 of the chromatography system 10. One or more springs elements 217, such as a coiled spring or elastomeric material, may be configured on a retainer surface 227 of the cartridge adapter 220 and configured to engage with an adapter-retainer surface 204 of an adapter retainer 200, to create a firm connection of the cartridge adapter with the cartridge adapter receiver, to prevent leaks of an analyte composition. The cartridge body 221 may be a monolithic part made from a single piece of material, such as being machined or otherwise made from a piece of metal.

An exemplary cartridge adapter 220 has a cartridge key 222 configured to fit within a keyway recess 212 extending from an adapter recess 219 of a cartridge adapter receiver 210. The cartridge adapter may have a cartridge recess 225 for receiving a chromatography cartridge therein and for coupling the inlet nipple of the chromatography cartridge with the inlet conduit 226. The inlet nipple 233 of the chromatography cartridge 230 may be a male fitting that is inserted into the cartridge adapter 220 to couple the inlet nipple with the inlet conduit 226 into the chromatography cartridge. Also, the cartridge adapter 220 has a centering feature 224 for centering within the cartridge receiver. The centering feature is a recess in the retainer surface 227 of the cartridge adapter 220 and may be configured to receive a tool for removal of the cartridge adapter 220 from the cartridge adapter receiver 210. The cartridge adapter body forms an insert surface 223 and the cartridge key 222 extends from this engagement surface to form a protrusion from the insert surface 223 for insertion into the keyway recess 212 that enables effective alignment.

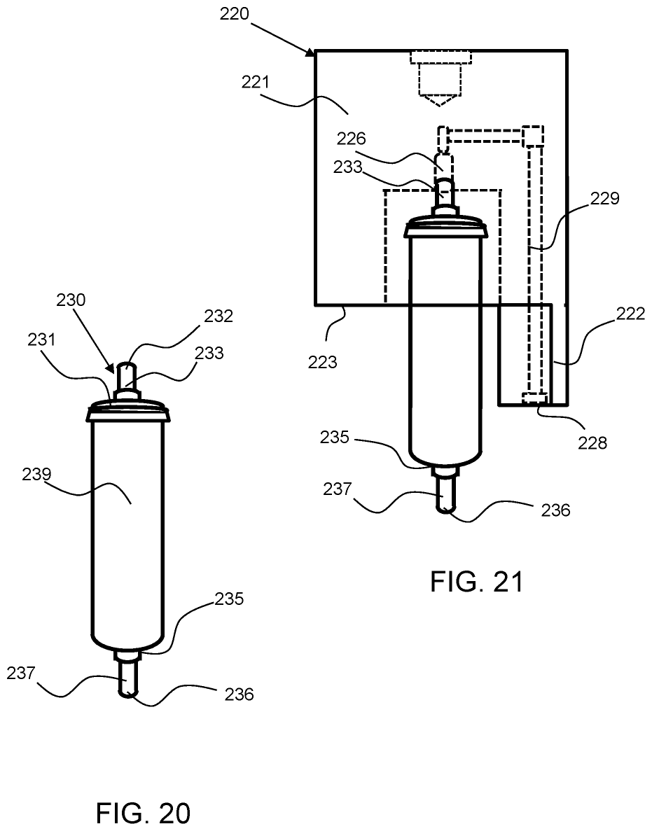

With reference to FIGS. 20 and 21, an exemplary chromatography cartridge 230 has an inlet end 231 with an inlet 232 and inlet nipple 233, and an outlet end 235 with an outlet 236 and outlet nipple 237. The outlet nipple 237 may be a male connector and the inlet nipple 233 may be a female connector. The chromatography cartridge 230 has an absorbent 239 therein. Sample gas, comprising a solvent and a specimen, flows into the inlet 232 through the inlet nipple 233 of the chromatography cartridge 230 and an analyte gas flows out of the outlet 236 through the outlet nipple 237 of the cartridge and to a detector of the chromatography system.

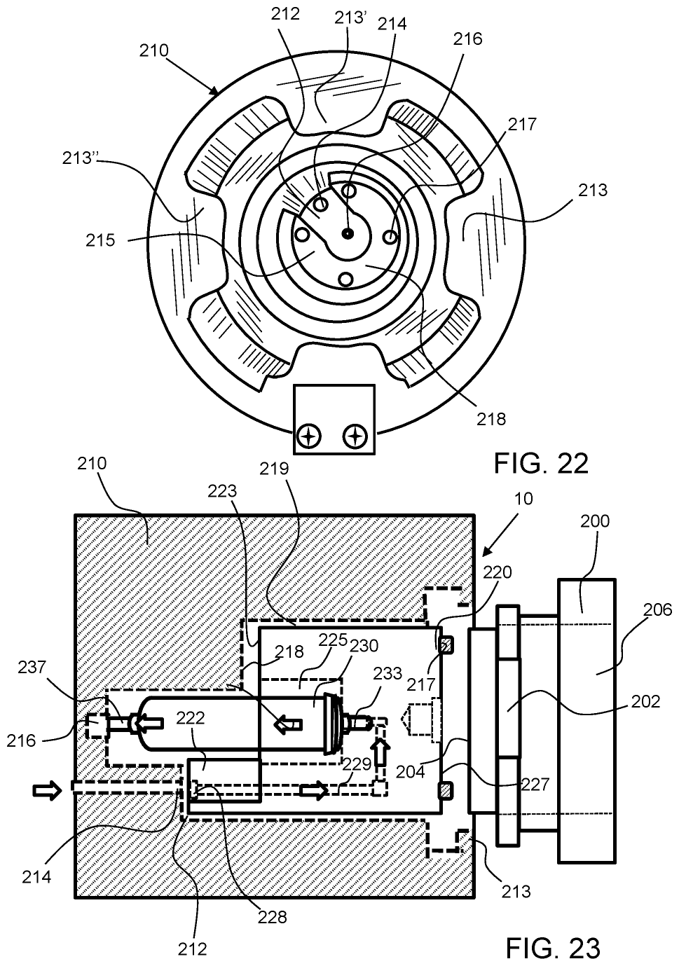

As shown in FIG. 21, the exemplary chromatography cartridge 230 is inserted into the cartridge adapter 220 and the cartridge adapter has a cartridge key 222 that extends from the insert surface for locating the cartridge adapter in a chromatography cartridge receiver. The inlet nipple 233 is coupled with the inlet conduit 226 of the cartridge adapter 220. The outlet nipple 237 is configured for coupling with the cartridge outlet nipple receiver 216 of the cartridge adapter receiver 210, shown in FIGS. 22 and 23.

Referring now to FIGS. 22 and 23, a cartridge adapter receiver 210 of a chromatography system has adapter opening 215 that extends in to a cartridge receiver surface 218. A keyway 212 for receiving the cartridge key 222 of the cartridge adapter 220 extends distal from insert surface 223 with respect to the adapter opening 215 in the cartridge adapter receiver. The cartridge key 222 may extend a fraction the cartridge receiver surface 218 and may extend about 40 degrees or less, about 30 degrees or less, about 20 degrees or less so that the cartridge receiver surface 218 provides a substantial surface for the insert surface 223 of the cartridge adapter. Likewise, the keyway recess 212 may be sized to correspond with the cartridge key and may extend about 40 degrees or less, about 30 degrees or less, about 20 degrees or less within the adapter opening or from the cartridge receiver surface 218. The chromatography cartridge adapter receiver 210 has a keyway 212, a recessed area from the adapter recess 219 that is sized for positive rotational location of the cartridge adapter therein. A process flow inlet coupler 214 for coupling with the process flow inlet 228 of the cartridge adapter 220, and a cartridge outlet nipple receiver 216 for coupling with the inlet nipple of the cartridge.

The process flow, as indicated by the bold arrows, includes an analyte suite composition, which may include one to seven analytes, a super critical CO2 and a solvent, are introduced through the process flow inlet coupler 214 which couples with the process flow inlet 228 of the cartridge adapter. The analyte suite composition then flows through the process flow conduit 229 to the inlet nipple 233 of the chromatography cartridge 230, through the cartridge and the absorbent 239, such as a silica media, to the outlet nipple 237 of the chromatography cartridge 230. The absorbent causes the analytes to pass through the cartridge at different speeds to stratify the analytes into separate analytes for analysis. The analytes then flow the cartridge outlet nipple receiver to then detector for analysis.

An adapter retainer 200 has an adapter-retainer surface 204 configured to engage with the retainer surface 227 of the cartridge adapter 220 and has retainer flanges 202 configured to rotate under the receiver flanges 213 to secure the cartridge adapter 220 to the cartridge adapter receiver 210. The adapter retainer 200 may have a handle portion 206 that extends out from the adapter recess 219 or from the cartridge adapter receiver 210, to allow a user to push the adapter retainer inward and rotate it to secure the receiver flanges 213 against the retainer flanges 220. The spring elements 217 are compressed to produce a force on the retainer flanges 202 against the receiver flanges 213 to secure the cartridge adapter in position within the adapter recess 219. Sealing the nipples of the chromatography cartridge to the cartridge adapter and process flow inlet 228 with the process flow inlet coupler 214 is difficult and often requires multiple attempts to get all three connections to seal simultaneously. The use of these spring elements aids in alignment and compression sealing of each of the three connections to ensure the process flow through the system. It is important to keep the process flow through the cartridge and not into the recess and to prevent gas, not process flow, into the analyte composition.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A chromatography system comprising:
a) a chromatography cartridge comprising:
i) an inlet end having an inlet nipple;
ii) an outlet end having an outlet nipple; and
iii) absorbent configured in the chromatography cartridge;
b) a cartridge adapter comprising;
i) a cartridge body having an insert surface;
ii) a cartridge key that extends from the insert surface;
iii) an inlet conduit coupled with the inlet nipple;
iv) a process flow inlet;
c) a cartridge adapter receiver comprising:
i) a process flow inlet coupler coupled with the process flow inlet of the cartridge adapter;
ii) a cartridge outlet nipple receiver coupled with the outlet nipple of the cartridge;
iii) an adapter recess for receiving the cartridge adapter therein and having a cartridge receiver surface;
adapter opening for receiving the cartridge adapter;
iv) a keyway recess extending from the cartridge receiver surface distal from the adapter opening;
v) a plurality of receiver flanges extending over an adapter opening to the adapter recess;
d) an adapter retainer having a plurality of retainer flanges located between the plurality of receiver flanges and the cartridge adapter;
wherein the adapter retainer is configured to rotate to position the retainer flanges between the plurality of receiver flanges and the cartridge adapter to secure the cartridge adapter to the cartridge adapter receiver.

2. The chromatography system of claim 1, wherein the keyway recess extends 40 degrees or less along the cartridge receiver surface.

3. The chromatography system of claim 1, further comprising a spring element to produce a force between the receiver flanges and the retainer flanges.

4. The chromatography system of claim 3, wherein the spring element is a coiled spring.

5. The chromatography system of claim 1, wherein the cartridge body is a one piece unit made from a single piece of material.

6. The chromatography system of claim 1, wherein the plurality of receiver flanges of the cartridge adapter receiver includes three or more receiver flanges.

7. The chromatography system of claim 1, wherein the cartridge adapter has a cartridge recess in the insert surface for receiving the inlet end of the chromatography cartridge.

8. The chromatography system of claim 7, wherein the cartridge extends from the cartridge recess in the insert surface of the cartridge adapter past the cartridge key to the outlet nipple.

9. The chromatography system of claim 1, wherein the process flow inlet of the cartridge adapter is on the cartridge key.

10. The chromatography system of claim 1, wherein the cartridge adapter further comprises a spring element configured on the retainer surface to produce a force between the receiver flanges and the retainer flanges.

11. A method of inserting a chromatography cartridge into a chromatography system comprising:
a) providing the chromatography system as described in claim 1;
b) inserting the chromatography cartridge into the cartridge adapter with the inlet nipple of the chromatography cartridge coupled with the inlet conduit of the cartridge adapter;
c) inserting the cartridge adapter with the chromatography cartridge coupled thereto into the cartridge adapter receiver; and
d) turning the adapter retainer to configure the retainer flanges under the receiver flanges to secure the cartridge adapter in the cartridge adapter receiver.

12. The method of claim 11, further comprising:
a) providing a spring element to produce a force between the receiver flanges and the retainer flanges;
b) pushing the cartridge adapter into the cartridge adapter receiver to compress the spring before turning the adapter retainer to secure the cartridge adapter in the cartridge adapter receiver.

13. The method of claim 12, wherein the spring element is a coiled spring.

14. The method of claim 11, wherein the keyway recess extends 40 degrees or less along the cartridge receiver surface.

15. The method of claim 11, wherein the cartridge body is a one piece unit made from a single piece of material.

16. The method of claim 11, wherein the plurality of receiver flanges of the cartridge adapter receiver includes three or more receiver flanges.

17. The method of claim 11, wherein the cartridge adapter has a cartridge recess in the insert surface for receiving the inlet end of the chromatography cartridge.

18. The method of claim 17, wherein the cartridge extends from the cartridge recess in the insert surface of the cartridge adapter past the cartridge key to the outlet nipple.

19. The method of claim 11, wherein the process flow inlet of the cartridge adapter is on the cartridge key.

20. The method of claim 11, wherein the cartridge adapter further comprises a spring element configured on the retainer surface to produce a force between the receiver flanges and the retainer flanges.
